(19) United States
(12) Patent Application Publication
(10) Pub. No.: US 2011/0298790 A1
(43) Pub. Date: Dec. 8, 2011

(54) IMAGE SIGNAL PROCESSING DEVICE AND IMAGE SIGNAL PROCESSING METHOD, AND COMPUTER PROGRAM

(75) Inventor: Shigeru Harada, Tokyo (JP)

(73) Assignee: SONY CORPORATION, Tokyo (JP)

(21) Appl. No.: 13/117,237

(22) Filed: May 27, 2011

(30) Foreign Application Priority Data
Jun. 4, 2010 (JP) P2010-128580

(51) Int. Cl. G06T 15/00

(52) U.S. Cl. 345/419

(57) ABSTRACT

An image signal processing device including: a central area control processing unit that enlarges or reduces a central image segment of a stereoscopic image signal by a magnification factor according to a desired stereoscopic effect; a surrounding area control processing unit that reduction-processes a surrounding image segment of the stereoscopic image signal by a corresponding magnification factor when the central area control processing unit enlarges the central image segment, and enlargement-processes a surrounding image segment of the stereoscopic image signal by a corresponding magnification factor when the central area control processing unit reduces the central image segment; and a transition area control processing unit that performs, in an image segment that transitions between the central image segment and the surrounding image segment, a process of connecting a gap between the enlargement and reduction factors of the central image segment and the surrounding image segment using non-linear scaling.

### BACKGROUND OF THE INVENTION

The present disclosure relates to an image signal processing device and an image signal processing method, and a computer program processing a stereoscopic image including a left eye image signal and a right eye image signal, and in particular, to an image signal processing device and an image signal processing method, and a computer program realizing an optimal stereoscopic effect by adjusting the amount of binocular parallax.

By displaying an image having parallax between the left and right eyes, it is possible to present a stereoscopic image that appears stereoscopic to an observer. As one method of presenting a stereoscopic image, there is a method of presenting an image with parallax to both eyes by making an observer wear glasses having special optical properties. For example, a time sharing stereoscopic image display system includes a combination of a display device displaying a plurality of images each different from one another in a time sharing manner, and shutter glasses that the observer of an image wears. The display device, at the same time as alternately screen displaying a left eye image and a right eye image in extremely short cycles, synchronizes with the cycles of the left eye image and the right eye image and provides images separately to the left eye and the right eye. On the other hand, the shutter glasses that an observer wears allow, while a left eye image is displayed, light to pass through a left eye portion of the shutter glasses and block light at a right eye portion. Further, while a right eye image is displayed, the right eye portion of the shutter glasses allows light to pass through and the left eye portion blocks light.

It is understood that, if a stereoscopic image is enlarged, the stereoscopic effect is increased as a result of an increase in the amount of binocular parallax (for example, refer to Japanese Unexamined Patent Application Publication No. 2004-349736). However, if the binocular parallax is too great, fusion of the left and right images becomes difficult, and eye strain or dizziness may be caused.

Further, when software with a large amount of projection from the screen frame or with a strong stereoscopic effect is viewed, straining or discomfort may be caused.

### SUMMARY OF THE INVENTION

It is desirable to provide an excellent image signal processing device and an image signal processing method, and a computer program, that are able to realize an optimal stereoscopic effect by adjusting an amount of binocular parallax.

It is further desirable to provide an excellent image signal processing device and an image signal processing method, and a computer program, that are able to realize an optimal stereoscopic effect by enlargement-processing or reduction-processing a stereoscopic image and changing the amount of binocular parallax, while not causing eye strain or dizziness.

According to an embodiment of the present disclosure, there is provided an image signal processing device including: a central area control processing unit that enlarges or reduces a central image segment of a stereoscopic image signal by a magnification factor according to a desired stereoscopic effect; a surrounding area control processing unit that reduction-processes a surrounding image segment of the stereoscopic image signal by a corresponding magnification factor when the central area control processing unit enlarges the central image segment, and enlargement-processes a surrounding image segment of the stereoscopic image signal by a corresponding magnification factor when the central area control processing unit reduces the central image segment; and a transition area control processing unit that performs, in an image segment that transitions between the central image segment and the surrounding image segment, a process of connecting a gap between the enlargement and reduction factors of the central image segment and the surrounding image segment using non-linear scaling.

In the configuration of the image signal processing device according to the embodiment of the present disclosure, the central area control processing unit may enlargement-process the central image segment when the stereoscopic effect of a stereoscopic image is emphasized, and may reduction-process the central image segment when the stereoscopic effect of a stereoscopic image is moderated.

In the configuration of the image signal processing device according to the embodiment of the present disclosure, the surrounding area control processing unit may lower the resolution or the contrast of an image signal of the surrounding image segment; and the transition area control processing unit may lower the resolution or the contrast of an image signal of the transitioning image segment.

In the configuration of the image signal processing device according to the embodiment of the present disclosure, the transition area control processing unit may enlarge in the horizontal direction and reduce in the vertical direction at portions that are long in the horizontal direction out of the transitioning segment while reducing in the horizontal direction and enlarging in the vertical direction at portions that are long in the vertical direction out of the transitioning segment when the central area control processing unit enlargement-processes the central image segment, and may reduce in the horizontal direction and enlarge in the vertical direction at portions that are long in the horizontal direction out of the transitioning segment while enlarging in the horizontal direction and reducing in the vertical direction at portions that are long in the vertical direction out of the transitioning segment when the central area control processing unit reduction-processes the central image segment.

According to another embodiment of the present disclosure, there is provided an image signal processing method including: enlarging or reducing a central image segment of a stereoscopic image signal by a magnification factor according to a desired stereoscopic effect; reduction-processing a surrounding image segment of the stereoscopic image signal by a corresponding magnification factor when the central area control processing enlarges the central image segment, and enlargement-processing a surrounding image segment of the stereoscopic image signal by a corresponding magnification factor when reducing the central image segment in the enlarging or reducing of the central image segment; and performing, in an image segment that transitions between the central image segment and the surrounding image segment, a process of connecting a gap between the enlargement and reduction factors of the central image segment and the surrounding image segment using non-linear scaling.

According to still another embodiment of the present disclosure, there is provided a computer program described as a computer-readable type so as to execute processing of a stereoscopic image signal on a computer, and for making the computer function as: a central area control processing unit that enlarges or reduces a central image segment of a stereoscopic image signal by a magnification factor according to a desired stereoscopic effect; a surrounding area control processing unit that reduction-processes a surrounding image segment of the stereoscopic image signal by a corresponding magnification factor when the central area control processing unit enlarges the central image segment, and enlargement-processes a surrounding image segment of the stereoscopic image signal by a corresponding magnification factor when the central area control processing unit reduces the central image segment; and a transition area control processing unit that performs, in an image segment that transitions between the central image segment and the surrounding image segment, a process of connecting a gap between the enlargement and reduction factors of the central image segment and the surrounding image segment using non-linear scaling.

A computer program according to the embodiment of the present disclosure is defined as a computer program described to be computer-readable so as to realize predetermined processes on a computer. In other words, by installing a computer program according to the sixth embodiment of the disclosure on a computer, a cooperative operation is exhibited on the computer, and the same operational effect as that of the image signal processing device of the embodiment of the present disclosure is obtained.

According to the present disclosure, it is possible to provide an excellent image signal processing device and an image signal processing method, and a computer program, that are able to realize an optimal stereoscopic effect by enlargement-processing or reduction-processing a stereoscopic image and changing the amount of binocular parallax, while not causing eye strain or dizziness.

According to the embodiments of the disclosure, it is possible to obtain a stereoscopic image signal that has a large amount of binocular parallax and an emphasized stereoscopic effect by enlarging the central image segment of a screen and reducing the surrounding image segment of the screen, and it is possible to obtain a stereoscopic image signal that has a reduced amount of binocular parallax and a moderated stereoscopic effect by reducing the central image segment of a screen and enlarging the surrounding image segment of the screen. Further, by connecting an image segment that transitions between the central image segment and the surrounding image segment of a screen using non-linear scaling, there are no image segments that are not visible.

According to the embodiment of the disclosure, by lowering the resolution or the contrast of an image signal of a surrounding image segment, it is possible to reduce a feeling of discomfort in response to an opposite stereoscopic effect to that of a central image segment. Further, by lowering the resolution or the contrast of an image signal of the transitioning image segment, it is possible to reduce a feeling of discomfort in response to changes in the enlargement and reduction factor.

Still more aims, characteristics, and advantages of the disclosure will be made clear in the embodiments of the disclosure and the detailed descriptions based on the attached drawings described below.

### BRIEF DESCRIPTION OF THE DRAWINGS

FIG. 1 is a diagram schematically illustrating a configuration of a stereoscopic image display system that is able to apply the disclosure;

FIG. 2 is a diagram illustrating a control operation of shutter glasses during an L sub-frame period;

FIG. 3 is a diagram illustrating a control operation of shutter glasses during an R sub-frame period;

FIG. 4A is a diagram illustrating a configuration example of an adjustment screen of a stereoscopic effect (provided that it is a case where the stereoscopic effect is emphasized);

FIG. 4B is a diagram illustrating a configuration example of an adjustment screen of a stereoscopic effect (provided that it is a case where the stereoscopic effect is moderated);

FIG. 5 is a diagram illustrating a state where the centre of a screen is enlarged while the surroundings are reduced;

FIG. 6 is a diagram illustrating a state where the centre of a screen is reduced while the surroundings are enlarged; and

FIG. 7 is a functional block diagram of performing a control process for realizing an adjustment method of a stereoscopic effect.

### DETAILED DESCRIPTION OF EMBODIMENTS

Hereinbelow, embodiments of the disclosure will be described in detail referring to the drawings.

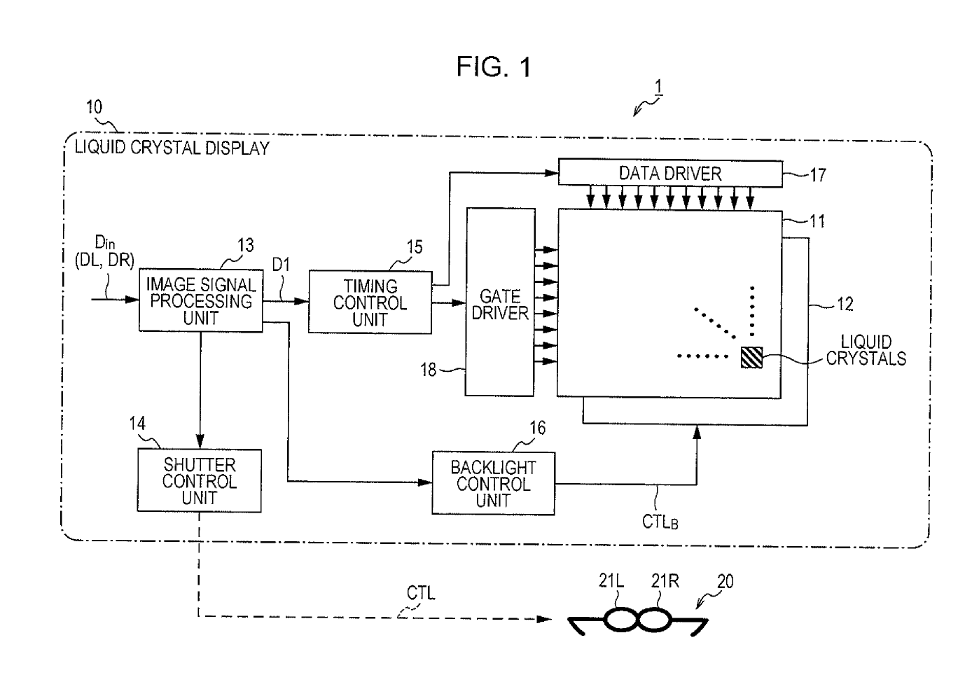

In FIG. 1 is schematically illustrated a configuration of a stereoscopic image display system 1 that is able to apply the disclosure. The stereoscopic image display system 1 shown in the diagram includes a liquid crystal display 10 that alternately screen displays a left eye image L and a right eye image R in extremely short cycles, and shutter glasses 20 that an observer wears on the head.

The liquid crystal display 10 is provided with a liquid crystal display panel 11, a backlight 12, an image signal processing unit 13, a shutter control unit 14 that controls an opening and closing timing of a shutter mechanism of the shutter glasses 20, a timing control unit 15, a backlight control unit 16, a data driver 17, and a gate driver 18. In the embodiment, the liquid crystal display 10 displays an image based on an input image signal Dᵢₙ that includes a right eye image signal D_{R} and a left eye image signal D_{L} having parallax between left and right.

The liquid crystal display panel 11 is, for example, an active matrix type that arranges a TFT for every pixel. The backlight 12 is a light source that irradiates light to the liquid crystal display panel 11. The backlight 12 is controlled to switch between the lighting (light emitting) action and turning off action thereof in a time sharing manner, based on a control signal CTL_{B} supplied from the backlight control unit 16.

As the backlight 12, for example, an LED (Light Emitting Diode), a CCFL (Cold Cathode Fluorescent Lamp), or the like may be used. However, if a CCFL is used, afterglow occurs easily, and further, the afterglow properties of each color of RGB may become different. Therefore, a backlight 12 using an LED that has little afterglow is described below.

The liquid crystal display panel 11 has a plurality of pixels arranged as a whole in a matrix shape, and performs image display based on the input image signal Dᵢₙ by modulating light emitted from the backlight 12 in accordance with a driving signal supplied from the gate driver 18 based on an image voltage supplied from the data driver 17. In the embodiment, the liquid crystal display panel 11 alternately displays, within a predetermined cycle such as one frame period, a right eye image R based on the right eye image signal D_{R} and a left eye image L based on the left eye image signal D_{L} in a time sharing manner.

The image signal processing unit 13 creates an image signal for the liquid crystal display panel 11 by performing control of the writing order (that is, the display order) of the right eye image signal D_{R} and the left eye image signal D_{L} to the liquid crystal display panel 11, based on the input image signal Dᵢₙ. In the embodiment, the image signal processing unit 13 creates, from the input image signal Dᵢₙ, an image signal D1 that is the left eye image signal D_{L} and the right eye image signal D_{R} arranged alternately within one frame period. Further, hereafter, out of one frame period, a display period of the left eye image L will be referred to as an “L sub-frame period” and a display period of the right eye image R will be referred to as an “R sub-frame period.”

Further, although the image signal processing unit realizes a desired stereoscopic effect by enlargement-processing or reduction-processing a stereoscopic image and changing the amount of binocular parallax, a detailed description relating to this point will be deferred to a later time.

The timing control unit 15 controls a driving timing of the gate driver 18 and the data driver 17, while also supplying the image signal D1 supplied from the image signal processing unit 13 to the data driver 17. The timing control unit 15 may also perform an overdrive process on the image signal D1.

The gate driver 18 sequentially drives each pixel within the liquid crystal panel 11 along a gate wire, in accordance with a timing control of the timing control unit 15.

The gate driver 17 supplies an image voltage based on the image signal D1 supplied from the timing control unit to each pixel of the liquid crystal display panel 11. Specifically, D/A conversion is performed on the image signal D1, an analog image signal equivalent to the image voltage is created, and the image signal is output to each pixel.

The shutter control unit 14 outputs, to the shutter glasses 20, a timing control signal CTL for controlling the switching between opening and closing of the left and right shutter mechanisms that corresponds to the output timings of the right eye image signal D_{R} and the left eye image signal D_{L} by the image signal processing unit 13.

The shutter glasses 20 make stereoscopic vision possible by being worn by an observer (not shown in FIG. 1) of the liquid crystal display 10. The shutter glasses 20 have a left eye lens 21L and a right eye lens 21R. On each of the left eye lens 21L and the right eye lens 21R is arranged a light-blocking shutter (not shown) for blocking light to an aperture. The light-blocking shutters include, for example, liquid crystal shutters and the like. An effective state (that is, a closed state) and an ineffective state (that is, an opened state) of a light-blocking function of these light-blocking shutters are controlled by the control signal CTL supplied from the shutter control unit 14.

The shutter control unit 14 performs control of the light-blocking shutters of the shutter glasses 20 in correspondence with each display period of the left eye image L and the right eye image R so that each of an opened state and a closed state of the left eye lens 21L and the right eye lens 21R to alternately switch therebetween. Specifically, a control for setting the light-blocking shutter of the left eye lens 21L to an opened state and the light-blocking shutter of the right eye lens 21R a closed state during an L sub-frame period while setting the initial light-blocking shutter of the right eye lens 21R to an opened state and the light-blocking shutter of the left eye lens 21L a closed state during an R sub-frame period is performed.

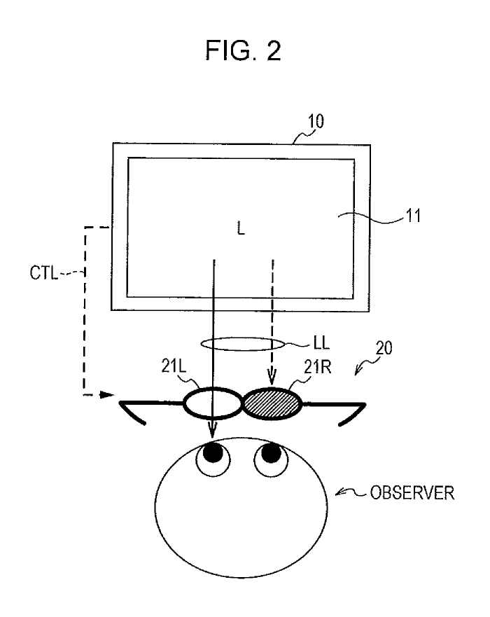

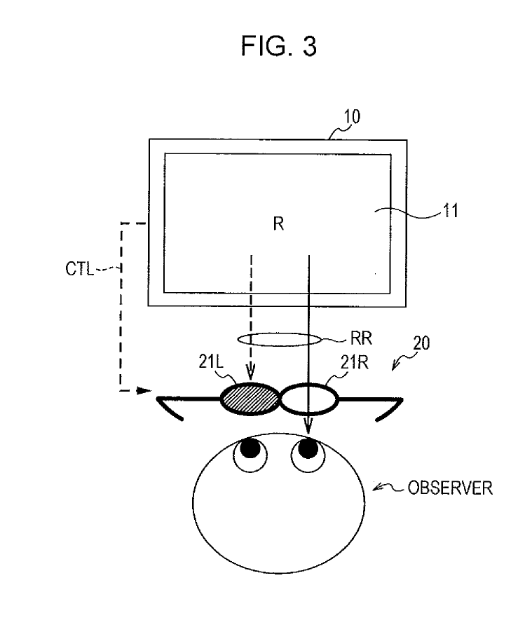

In FIG. 2 is illustrated a control operation of the shutter glasses 20 during an L sub-frame period. As shown in the diagram, during an L sub-frame period, by a control signal CTL from the shutter control unit 14, the shutter of the left eye lens 21L is in an opened state, the shutter of the right eye lens 21R is in a closed state, and a display light LL based on the left eye image L passes through only the left eye lens 21L. Further, in FIG. 3 is illustrated a control operation of the shutter glasses 20 during an R sub-frame period. As shown in the diagram, during an R sub-frame period, by a control signal CTL from the shutter control unit 14, the shutter of the right eye lens 21R is in an opened state, the shutter of the left eye lens 21L is in a closed state, and a display light RR based on the right eye image R passes through only the right eye lens 21R.

In the stereoscopic image display system shown in FIG. 1, if the image signal processing unit 13 enlargement-processes or reduction-processes a stereoscopic image, the amount of binocular parallax changes and a desired stereoscopic effect is able to be realized.

However, if the binocular parallax is too great, fusion of the left and right images becomes difficult, and eye strain or dizziness may be caused. Further, when software with a large amount of projection from the screen frame or with a high effectiveness of stereoscopic effect is viewed, straining or discomfort may be caused.

Therefore, the present inventors propose a method of realizing an optimal stereoscopic effect without causing eye strain or dizziness by dividing an image (input stereoscopic image) into a central area and a surrounding area and performing enlargement and reduction for each area.

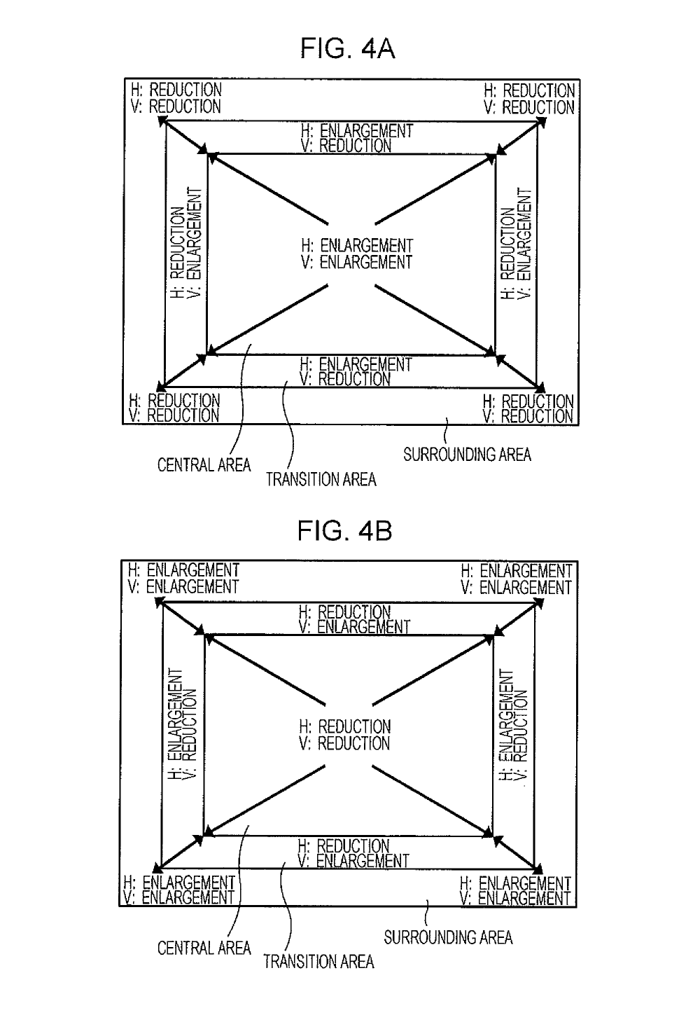

In FIG. 4 is illustrated a realization method of a stereoscopic effect according to the disclosure. In the adjustment screen of a stereoscopic effect shown in the diagram, the image segment is divided into a central area, a surrounding area, and a transition area between the central area and the surrounding area. However, FIG. 4A is a case where the centre of a screen is enlarged to emphasize the stereoscopic effect, and FIG. 4B is a case where the centre of a screen is reduced to moderate the stereoscopic effect.

If the center of a screen is enlarged, the amount of binocular parallax is increased and the stereoscopic effect is heightened. In this case, the central area is enlarged by a magnification factor of N in both the horizontal direction (H) and the vertical direction (V). On the other hand, if expressed using a function f(N) with N as an argument, the surrounding area is reduced by a magnification factor of 1/f(N) in both the horizontal direction (H) and the vertical direction (V). f(N) is a monotone increasing function, and typically f(N)=N.

The transition area connects a gap between the enlargement and reduction factors of the central area and the surrounding area in the horizontal direction (H) and the vertical direction (V) using non-linear scaling. In the example shown in FIG. 4A, the transition area is substantially frame-shaped, out of which the portions that are long in the horizontal direction are enlarged in the horizontal direction (H) and reduced in the vertical direction (V). Further, the portions that are long in the vertical direction out of the frame-shape are reduced in the horizontal direction (H) and enlarged in the vertical direction (V). Further, the enlargement and reduction factor of the transition area becomes enlarged by a magnification factor closer to N when closer to the central area, the enlargement factor becomes gradually lower further away from the central area, and the enlargement and reduction factor of the transition area becomes reduced by a magnification factor closer to 1/f(N) when closer to the surrounding area. Although the stereoscopic effect in the transition area becomes subtle, there are no image segments that are not visible.

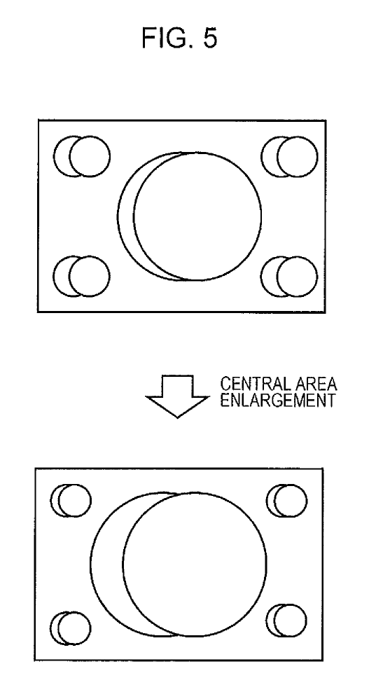

In FIG. 5 is shown a state where the center of a screen has been enlarged while the surroundings have been reduced. It can be understood that the amount of binocular parallax increases at the center and a stereoscopic effect is emphasized.

Further, the surrounding area and the transitioning area significantly reduce resolution and contrast. Although an image segment of the surrounding area exhibits a reverse stereoscopic effect to the central area, by lowering the frequency property or the contrast, it is possible to reduce a feeling of discomfort.

Conversely, if the center of a screen is reduced, front and rear effect is reduced, and a desirable stereoscopic effect is obtained. In this case, the central area is reduced by a magnification factor of 1/N in both the horizontal direction (H) and the vertical direction (V). On the other hand, the surrounding area is, if expressed using the function f(N) with N as an argument, enlarged by a factor of f(N) in both the horizontal direction (H) and the vertical direction (V). f(N) is a monotone increasing function, and typically f(N)=N.

The transition area connects a gap between the enlargement and reduction factors of the central area and the surrounding area in the horizontal direction (H) and the vertical direction (V) using non-linear scaling. In the example shown in FIG. 4B, the transition area is substantially frame-shaped, out of which the portions that are long in the horizontal direction are reduced in the horizontal direction (H) and enlarged in the vertical direction (V). Further, the portions that are long in the vertical direction out of the frame shape are enlarged in the horizontal direction (H) and reduced in the vertical direction (V). Further, the enlargement and reduction factor of the transition area becomes reduced by a magnification factor closer to 1/N when closer to the central area, the enlargement factor becomes gradually higher further away from the central area, and the enlargement and reduction factor of the transition area becomes enlarged by a magnification factor closer to f(N) when closer to the surrounding area. Although the stereoscopic effect in the transition area becomes subtle, there are no image segments that are not visible.

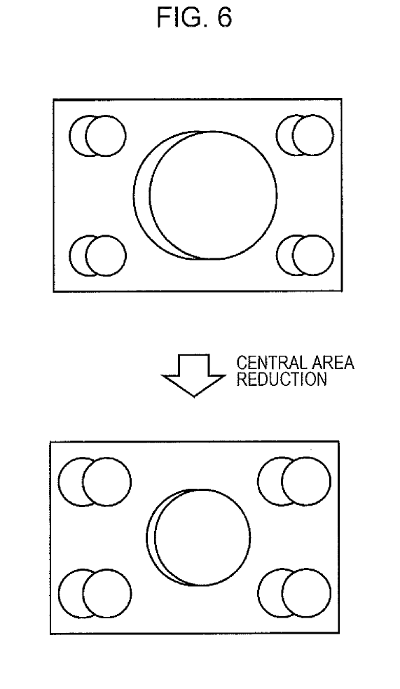

In FIG. 6 is shown a state where the center of a screen is reduced while the surroundings are enlarged. It can be understood that the binocular parallax is decreased at the center and the stereoscopic effect is moderated.

Further, the surrounding area and the transition area are significantly reduced in resolution and contrast. Although an image segment of the surrounding area exhibits a reverse stereoscopic effect to the central area, by lowering the frequency property or the contrast, it is possible to reduce a feeling of discomfort.

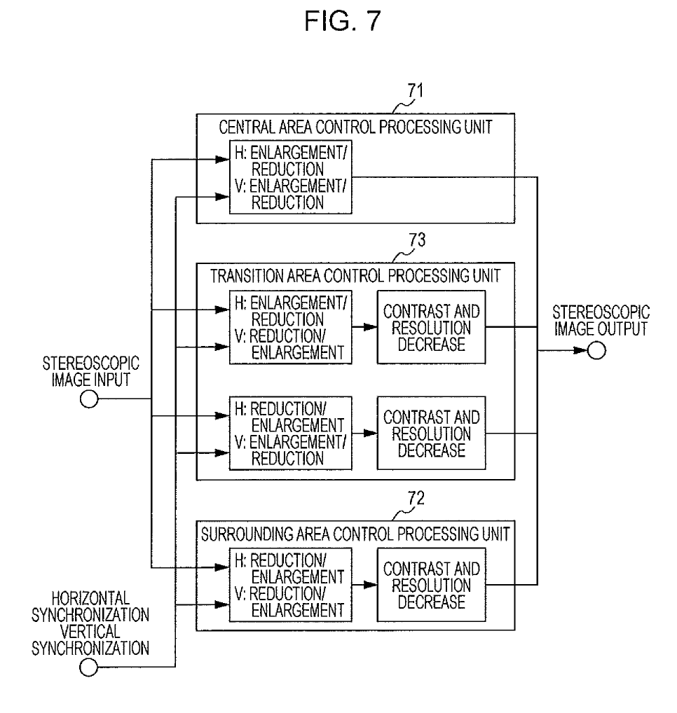

In FIG. 7 is shown a functional block diagram of performing a control process for realizing an adjustment method of a stereoscopic effect described above.

A central area control processing unit 71 performs enlargement and reduction processing of the central area out of the image segments. In a case where the stereoscopic effect is emphasized, the central area control processing unit 71 enlarges the central area by a magnification factor of N in both the horizontal direction (H) and the vertical direction (V). The enlargement factor N is determined according to a desired stereoscopic effect. Conversely, in a case where the stereoscopic effect is moderated, the central area control processing unit 71 reduces the central area by a magnification factor of 1/N in both the horizontal direction (H) and the vertical direction (V).

A surrounding area control processing unit 72 performs, in accordance with the enlargement and reduction processing of the central area, enlargement and reduction processing of the surrounding area out of the image segments. In a case where the stereoscopic effect in the central area is emphasized, the surrounding area control processing unit 72 reduces the surrounding area by a magnification factor of 1/f(N) in both the horizontal direction (H) and the vertical direction (V). Conversely, in a case where the stereoscopic effect in the central area is moderated, the surrounding area control processing unit 72 enlarges the surrounding area by a magnification factor of f(N) in both the horizontal direction (H) and the vertical direction (V).

Further, the surrounding area control processing unit 72 significantly reduces resolution and contrast of the surrounding area. Although an image segment of the surrounding area exhibits a reverse stereoscopic effect to the central area, by lowering the frequency property or the contrast, it is possible to reduce a feeling of discomfort.

A transition area control processing unit 73 performs, in accordance with the enlargement and reduction processing of the central area and the enlargement and reduction processing of the surrounding area, in the transition area out of the image segments, a process of connecting a gap between the enlargement and reduction factors of the central area and the surrounding area using non-linear scaling in the horizontal direction (H) and the vertical direction (V).

In a case where the stereoscopic effect in the central area is emphasized, the transition area control processing unit 73 enlarges the portions that are long in the horizontal direction out of the transition area in the horizontal direction (H) and reduces in the vertical direction (V), and reduces the portions that are long in the vertical direction out of the transition area in the horizontal direction (H) and enlarges in the vertical direction (V). Further, the enlargement and reduction factor of the transition area becomes enlarged by a magnification factor closer to N when closer to the central area, the enlargement factor becomes gradually lower further away from the central area, and the enlargement and reduction factor of the transition area becomes reduced by a magnification factor closer to 1/f(N) when closer to the surrounding area.

Conversely, in a case where the stereoscopic effect in the central area is moderated, the transition area control processing unit 73 reduces the portions that are long in the horizontal direction out of the transition area in the horizontal direction (H) and increases in the vertical direction (V), and enlarges the portions that are long in the vertical direction out of the transition area in the horizontal direction (H) and reduces in the vertical direction (V). Further, the enlargement and reduction factor of the transition area becomes reduced by a magnification factor closer to 1/N when closer to the central area, the enlargement factor becomes gradually higher further away from the central area, and the enlargement and reduction factor of the transition area becomes enlarged by a magnification factor closer to f(N) when closer to the surrounding area.

Further, the transition area control processing unit significantly reduces resolution and contrast of the transition area. Although the enlargement and reduction factor in an image segment of the transition area changes, by lowering the frequency property or the contrast, it is possible to reduce a feeling of discomfort.

The present disclosure contains subject matter related to that disclosed in Japanese Priority Patent Application JP 2010-128580 filed in the Japan Patent Office on Jun. 4, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image signal processing device comprising:
a central area control processing unit that enlarges or reduces a central image segment of a stereoscopic image signal by a magnification factor according to a desired stereoscopic effect;
a surrounding area control processing unit that reduction-processes a surrounding image segment of the stereoscopic image signal by a corresponding magnification factor when the central area control processing unit enlarges the central image segment, and enlargement-processes a surrounding image segment of the stereoscopic image signal by a corresponding magnification factor when the central area control processing unit reduces the central image segment; and
a transition area control processing unit that performs, in an image segment that transitions between the central image segment and the surrounding image segment, a process of connecting a gap between the enlargement and reduction factors of the central image segment and the surrounding image segment using non-linear scaling.

2. The image signal processing device according to claim 1, wherein the central area control processing unit enlargement-processes the central image segment when the stereoscopic effect of a stereoscopic image is emphasized, and reduction-processes the central image segment when the stereoscopic effect of a stereoscopic image is moderated.

3. The image signal processing device according to claim 1, wherein:
the surrounding area control processing unit lowers the resolution or the contrast of an image signal of the surrounding image segment; and
the transition area control processing unit lowers the resolution or the contrast of an image signal of the transitioning image segment.

4. The image signal processing device according to claim 1, wherein the transition area control processing unit enlarges in the horizontal direction and reduces in the vertical direction at portions that are long in the horizontal direction out of the transitioning segment while reducing in the horizontal direction and enlarging in the vertical direction at portions that are long in the vertical direction out of the transitioning segment when the central area control processing unit enlargement-processes the central image segment, and reduces in the horizontal direction and enlarges in the vertical direction at portions that are long in the horizontal direction out of the transitioning segment while enlarging in the horizontal direction and reducing in the vertical direction at portions that are long in the vertical direction out of the transitioning segment when the central area control processing unit reduction-processes the central image segment.

5. An image signal processing method comprising:
enlarging or reducing a central image segment of a stereoscopic image signal by a magnification factor according to a desired stereoscopic effect;
reduction-processing a surrounding image segment of the stereoscopic image signal by a corresponding magnification factor when the central area control processing enlarges the central image segment, and enlargement-processing a surrounding image segment of the stereoscopic image signal by a corresponding magnification factor when reducing the central image segment; and
performing, in an image segment that transitions between the central image segment and the surrounding image segment, a process of connecting a gap between the enlargement and reduction factors of the central image segment and the surrounding image segment using non-linear scaling.

6. A computer program described as a computer-readable type so as to execute processing of a stereoscopic image signal on a computer, and for making the computer function as:
a central area control processing unit that enlarges or reduces a central image segment of a stereoscopic image signal by a magnification factor according to a desired stereoscopic effect;
a surrounding area control processing unit that reduction-processes a surrounding image segment of the stereoscopic image signal by a corresponding magnification factor when the central area control processing unit enlarges the central image segment, and enlargement-processes a surrounding image segment of the stereoscopic image signal by a corresponding magnification factor when the central area control processing unit reduces the central image segment; and
a transition area control processing unit that performs, in an image segment that transitions between the central image segment and the surrounding image segment, a process of connecting a gap between the enlargement and reduction factors of the central image segment and the surrounding image segment using non-linear scaling.
